(19) United States
(12) Patent Application Publication
(10) Pub. No.: US 2008/0114863 A1
(43) Pub. Date: May 15, 2008

(54) SYSTEM AND METHOD OF CONFIGURING NETWORK INFRASTRUCTURE USING FUNCTIONAL BUILDING BLOCKS

(75) Inventors: Michael E. Baskey, Wappingers Falls, NY (US); Lap Thiet Huynh, Cary, NC (US); John Reumann, Croton on Hudson, NY (US); Debanjan Saha, Mohegan Lake, NY (US); Sambit Sahu, Hopewell Junction, NY (US); Dinesh Chandra Verma, Mount Kisco, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/559,950

(22) Filed: Nov. 15, 2006

(51) Int. Cl. G06F 15/177

(52) U.S. Cl. 709/222

(57) ABSTRACT

A method of, and system for, configuring a network infrastructure, which includes representing the network infrastructure as a composition of a predetermined number of functional building blocks, configuring a network blue print based on the predetermined number of functional building blocks, and mapping the predetermined number of functional building blocks onto available physical resources of the network infrastructure, such that network configuration can be automated for a wide set of services representing network configuration as a functional composition of elemental blocks.

### BACKGROUND OF THE INVENTION

1. Field of the Invention

The present invention generally relates to a system and method of configuring network infrastructure using functional building blocks. Particularly, the exemplary aspects of the present invention provide a functional approach towards network configuration such that network configuration can be automated for a wide set of services by representing network configuration as a functional composition of elemental blocks.

2. Description of the Conventional Art

Providing network connectivity requires configuration of several different devices—based on the scenario, the complexity of which varies from configuring a single network access card to thousands of different network devices. Thus, network connectivity provisioning can be a difficult problem.

For example, configuration may be required at a large number of network devices, such as firewalls, routers, switches, load balancers, etc. Different vendors may have different implementations. Also, conflicting configurations across connections may be possible.

Ensuring the appropriate conflict free configuration, and providing management control for such heterogeneous and often complex set of devices can be quite involved.

Typically, in conventional systems and methods, such configurations are accomplished using fine-tuned configuration templates through manual intervention. For example, system administrators may use fine-tuned configuration templates, which may be designed and home-grown for each installation. However, it is often difficult to keep up-to-date changes in such a site installation.

There also are conventional approaches that try to automate such an involved process by providing end-to-end service templates for each configuration step.

However, given the heterogeneous device types, and several different conventional approaches for achieving the same end-result, the above static service template approach leads to an undesirable explosion of configuration choices.

On the other hand, some of these conventional approaches try to reduce the configuration set explosion problem by providing service templates for virtualized devices. However, one problem with such conventional approaches is that they generally are not scalable because, for example, there is a one-to-one mapping between physical to virtual device which makes the configuration choices very limited without increasing the number of virtual devices.

### SUMMARY OF THE INVENTION

In view of the foregoing and other exemplary problems, drawbacks, and disadvantages of the conventional methods and structures, an exemplary feature of the present invention is to provide a method and system of configuring network infrastructure using functional building blocks. Particularly, the exemplary aspects of the present invention provide a functional approach towards network configuration such that network configuration can be automated for a wide set of services representing network configuration as a functional composition of elemental blocks.

Instead of describing configuration towards a set of network devices, the exemplary aspects of the present invention's configuration is described in terms of a set of functional network building blocks.

These functional building blocks preferably are configured to realize the required network connectivity service. The functional blocks preferably are then mapped onto available physical network resources to achieve the network configuration.

By providing this separation from physical devices through the functional blocks, the exemplary aspects of the present invention can achieve a scalable, realizable automated network configuration for a wide range of network scenarios.

In an illustrative, non-limiting aspect of the invention, a method of configuring a network infrastructure includes representing the network infrastructure as a composition of a predetermined number of functional building blocks, configuring a network blue print based on the predetermined number of functional building blocks, and mapping the predetermined number of functional building blocks onto available physical resources of the network infrastructure.

In another exemplary aspect of the invention, a system for configuring a network infrastructure includes a representing unit that represents the network infrastructure as a composition of a predetermined number of functional building blocks, a configuring unit that configures a network blue print based on the predetermined number of functional building blocks, and a mapping unit that maps the predetermined number of functional building blocks onto available physical resources of the network infrastructure based on the network blue print.

In yet another exemplary aspect of the invention, a system for configuring a network infrastructure includes means for representing the network infrastructure as a composition of a predetermined number of functional building blocks, means for configuring a network blue print based on the predetermined number of functional building blocks, and means for mapping the predetermined number of functional building blocks onto available physical resources of the network infrastructure based on the network blue print.

The exemplary aspects of the present invention are capable of providing an abstract representation without any knowledge of network devices. Thus, the present invention allows an application to specify connectivity in terms of its functionality requirement. Moreover, the application need not know the actual devices that are present. According to the present invention, a function advantageously may be mapped to a different set of devices based on availability and existing configurations. The present invention also is capable of providing a higher possibility of satisfying a connectivity request.

### BRIEF DESCRIPTION OF THE DRAWINGS

The foregoing and other exemplary purposes, aspects and advantages will be better understood from the following detailed description of exemplary aspects of the invention with reference to the drawings, in which:

FIG. 1 illustrates an exemplary method 100, according to the present invention;

FIG. 2 illustrates an exemplary system 200, according to the present invention;

FIG. 3 illustrates another exemplary system 300, according to the present invention;

FIG. 4 exemplary illustrates a table 400 of functional representations, according to the present invention;

FIG. 5 exemplary illustrates a schematic 500 of the manner in which functional building blocks can be stacked, according to the present invention;

FIG. 6 illustrates an exemplary blue print 600 for a grid deployment, according to the present invention;

FIGS. 7A and 7B illustrate an example of mapping abstract connectivity onto network fabric, as illustrated in FIG. 6, according to the present invention;

FIGS. 8A-8B illustrates an exemplary method of setting up a template for blue print 600, as illustrated in FIG. 6, according to the present invention.

FIG. 9 illustrates an exemplary hardware/information handling system 900 for incorporating the present invention therein;

FIG. 10 illustrates a signal bearing medium 1000 (e.g., storage medium) for storing steps of a program of a method according to the present invention.

### DETAILED DESCRIPTION OF EXEMPLARY ASPECTS OF THE INVENTION

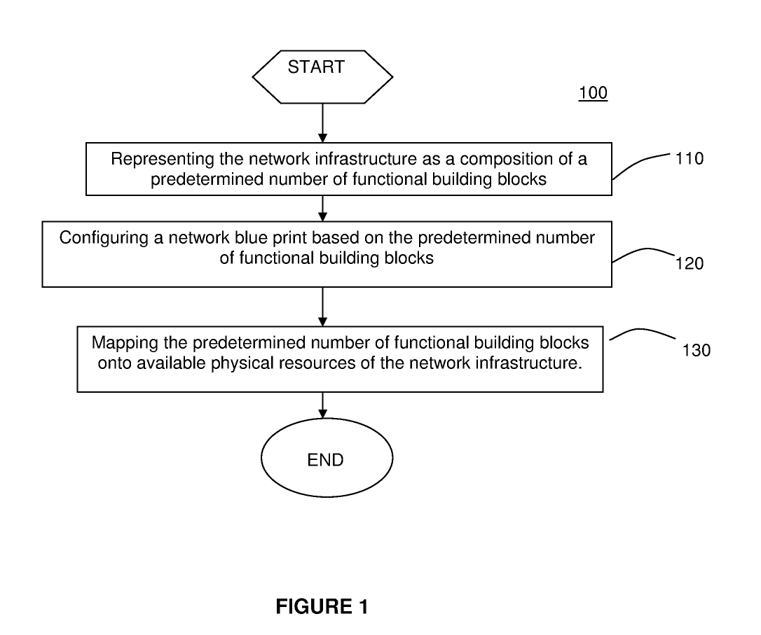

Referring now to the drawings, and more particularly to FIGS. 1-10, there are shown exemplary aspects of the method and structures according to the present invention.

The unique and unobvious features of the exemplary aspects of the present invention are directed to a novel system and method of configuring network infrastructure using functional building blocks. The exemplary aspects of the present invention provide a functional approach towards network configuration such that network configuration can be automated for a wide set of services representing network configuration as a functional composition of elemental blocks.

For example, with reference to FIGS. 1-3, instead of describing configuration towards a set of network devices, the present invention's exemplary configuration is described in terms of a set of functional network building blocks. These functional building blocks preferably can be configured to realize the required network connectivity service. The functional blocks preferably can then be mapped onto available physical network resources to achieve the network configuration.

By providing this separation from physical devices through the functional blocks, the exemplary aspects of the present invention are capable of achieving a scalable, realizable automated network configuration for a wide range of network scenarios.

With reference again to FIG. 1, an exemplary method 100 of the invention includes three basic components:
1) representing a network as a composition of a predetermined number of functional building blocks (e.g., five (5) functional building blocks) (e.g., see step 110);
2) defining network blue prints as a composition of these functional building blocks (e.g. see step 120); and
3) executing a mapping algorithm for mapping functional blocks onto available physical resources (e.g., see step 130).

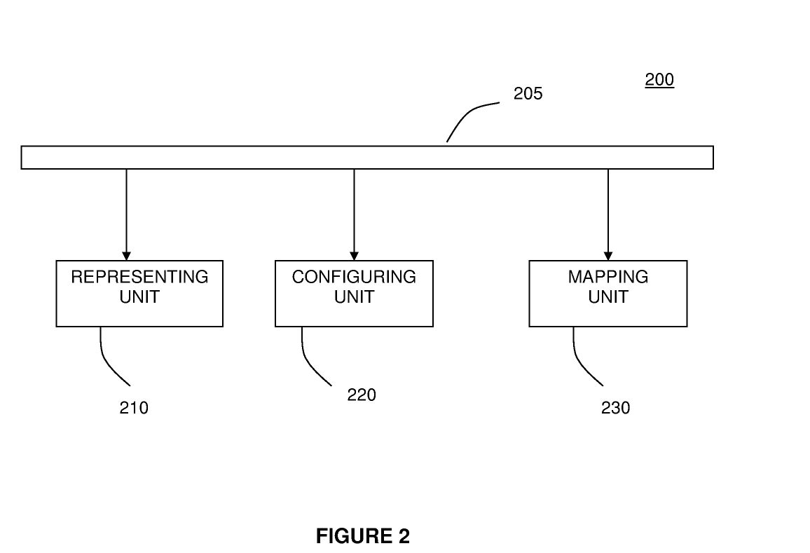

Somewhat similarly, with reference to FIG. 2, an exemplary system 200 includes a representing unit (210) that represents the network infrastructure as a composition of a predetermined number of functional building blocks, a configuring unit (220) that configures a network blue print based on the predetermined number of functional building blocks, and a mapping unit (230) that maps the predetermined number of functional building blocks onto available physical resources of the network infrastructure based on the network blue print. The representing unit (210), configuring unit (220), and mapping unit (230) can communicate with each other, for example, through bus (205).

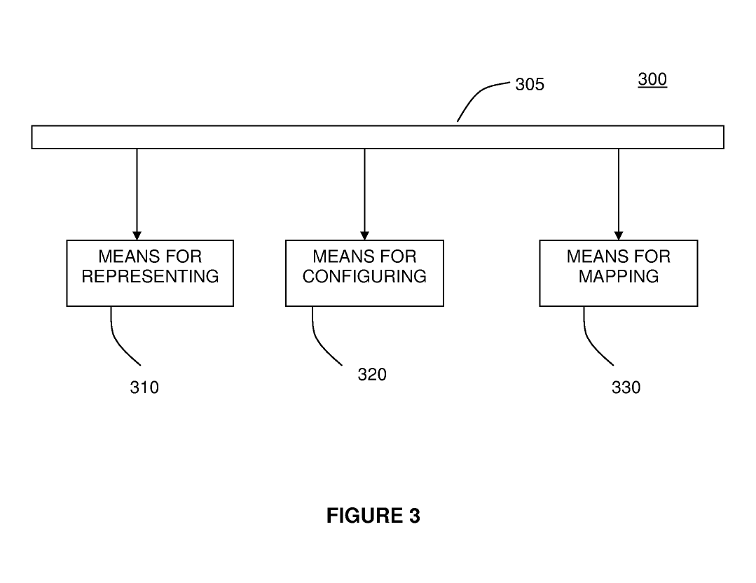

With reference to FIG. 3, an exemplary system 300 includes means for representing (310) the network infrastructure as a composition of a predetermined number of functional building blocks, means for configuring (320) a network blue print based on the predetermined number of functional building blocks, and means for mapping (330) the predetermined number of functional building blocks onto available physical resources of the network infrastructure based on the network blue print. The means for representing (310), means for configuring (320), and means for mapping (330) are capable of communicating with each other, for example, through bus (305).

Functional Building Blocks

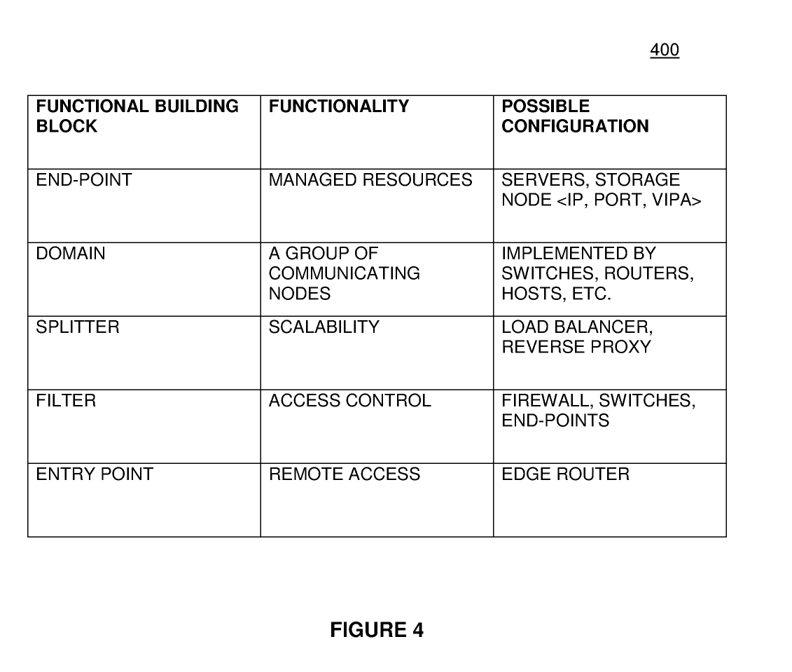

With reference to FIG. 4, some exemplary functional representations according to the present invention will now be described. As illustrated in FIG. 4, the functional composition of a network can be defined to include five building blocks, thereby providing an abstract representation without any device knowledge.

For example, according to a preferred exemplary aspect of the present invention, five logical building blocks can provide functional representation of “typical” network connectivity:
1) SPLITTER
For purposes of this disclosure, “splitters” generally can be defined as network components that distribute network traffic based on IP (Internet Protocol) source address, destination address, protocol, and destination port equally among the endpoints of one domain to which they are attached. All packets belonging to one flow [TCP (Transmission Control Protocol) or UDP (User Datagram Protocol) (controlled by a configurable timeout)]. A splitter represents the end-points of a domain behind a virtual end-point, i.e., the splitter itself may be viewed as and end-point in other domains.
2) ENTRY POINT
For purposes of this disclosure an “entry point” generally provides a tunneling function that relays traffic from one domain to another.
3) DOMAIN
For purposed of this disclosure “domain” generally defines a set of end-points that may collaborate to provide a desired network service.
4) END-POINTS
For purposes of this disclosure, “end-points” generally can be defined as network participants described by vector <real IP addr (real Internet Protocol Address), virtual IP addr (virtual internet protocol address), protocol, port>. That is, “end points” generally can be defined as (real IP, virtual IP, protocol, port) vectors. If one of the positions is set to a wildcard symbol, then all of the successive positions are wildcard symbols. In general an end-point can be designed to capture an application. Typically, an application listens on an IP (internet protocol) address, or port.
5) FILTER
For purposes of this disclosure, a “filter” generally restricts traffic flow into and out of a domain. Filters may be specified to restrict traffic to a destination endpoint inside the domain to which a filter is attached or from an endpoint to an address outside the domain.

The details of the above described exemplary functional building blocks will be described in more detail below.

It is noted that, for purposes of this disclosure, a functional block exemplarily describes the logical function it provides in a network. The realization of this function may be provided by more than one physical resource. This decoupling between the physical and logical aspects is one important feature of the network configuration according to the exemplary aspects of the present invention.

It is also noted that such decoupling is different from the decoupling that is provided by virtualized devices. That is, such a decoupling only achieves the isolation between the real configuration of devices and the logical configuration.

However, there is already an implicit one-to-one mapping between virtual devices and physical devices. The present invention exemplarily describes how the functional representation of a network according to the present invention is able to truly provide automated network configuration in a scalable manner.

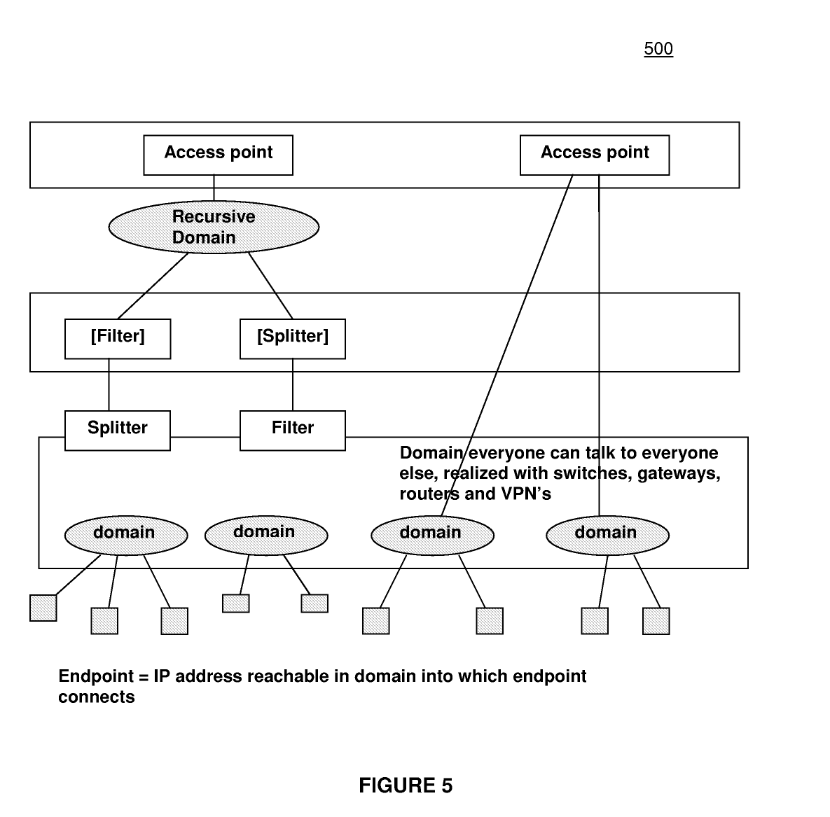

Turning to FIG. 5, an example of the manner in which such functional building blocks can be stacked is illustrated.

Some examples of defining blue prints as a composition of functional blocks according to the present invention will now be described.

For example, typical network deployments can be a functional composition of the five exemplary building blocks, as described above in a preferred aspect of the invention.

For example, a three-tier web site would consist of three domains (i.e., web, application and dbase), a splitter that divides traffic equally among web servers, and followed by a set of filters which access the end-points.

It is noted that while these functionalities can be achieved by single firewalls and load balancer combinations, the same objective can be achieved by an arbitrary combination of network appliances.

Network Blue Prints

The set combinations of the above five functional blocks preferably can be defined as network blue prints. In particular, the exemplary aspects of the invention can define, for example, the following blue prints to facilitate a wide range of network services in a real network setting:

A. GRID DEPLOYMENT:

For purposes of the present invention, “grid deployment” can create a domain, for example, by allocating a set of end-points to a customer and providing appropriate connectivity with access control.

B. MULTI-TIER WEB SITE:

For purposes of the present invention, “multi-tier web site” can configure the network connectivity for a multi-tier web site.

C. WEB SERVER FARM

D. REMOTE BRANCH OFFICE

Using such exemplary blue prints of functional blocks, the typical network configurations can be expressed as parameters to these limited set of blue prints.

While some exemplary aspects of the invention may lose some flexibility, for example, in network architectural design and highly specialized device features, it is noted that even such exemplary aspects gain considerably with respect to at least: 1) time to configuration; 2) reproducibility of network configuration; and 3) providing predictable software run-time network environment.

Mapping

Some exemplary aspects of mapping blue prints with functional blocks onto available resources according to the present invention will now be described.

Once a blue print (e.g., that consists of a composition of functional building blocks) is chosen for implementing a network service, each block in the blue print can be mapped onto appropriate physical resources.

The mapping onto physical resources preferably should be such that the configuration requirement of each block in the blue print preferably can be satisfied by the overall mapping onto physical resources.

It is noted that each physical device may be handling more than one network connectivity service. Thus, in the mapping process, potential conflicts across the configurations preferably should be taken into consideration.

The mapping process preferably takes resource connectivity details, current network configuration, and a blue print with the configuration parameters as the input. Thus, the problem of mapping preferably can be viewed as a constraint satisfaction problem in which a requirement graph is mapped onto a resource graph with constraints.

Exemplary details of the mapping algorithm are provided below in the example descriptions of each building block set forth below.

Applicants have recognized that conventional network configuration management software (such as those software provided by Ciscoworks, Rendition, Nortel, Goldwire, etc.) only provide a proxy function to better interface with a heterogeneous hardware devices. However, these do not provide any guidance in managing the end-to-end network configuration of larger data center installation, etc., where several devices are to be configured in an inter-related manner.

Pattern-based network configuration such as NCM (Network Configuration Management), as described in U.S. Patent Application Publication 2003/0135,596 A1 (which is incorporated herein by reference in its entirety) provides very detailed mappings of high level workflows into individual physical device configurations. However, in this approach, a pattern describes a specific network configuration for a specific network service.

Such an approach generally is not scalable because every pattern for every installation may need to be customized. While some exemplary aspects of the present invention may sacrifice, for example, some very specialized customizations, the exemplary features of the present invention can provide the advantage of being capable of addressing a wide range of configurations.

Some example of each of the exemplary functional building blocks will now be described.

According to the exemplary aspects of the present invention, it is important to note that the introduced abstractions are only abstract network building blocks that may map to one or more network appliances (potentially of different types).

A. End-Points

End points generally are defined as (real IP, virtual IP, protocol, port) vectors. If one of the positions is set to a wildcard symbol, then all of the successive positions are wildcard symbols. In general, an end-point can be designed to capture an application. Typically, an application listens on an IP (internet protocol) address, or port.

B. Domain

A set of end-points may collaborate in order to accomplish a specific component service. The end-points of a domain can communicate with each other without restrictions. This can be a virtualized, location-independent broadcast domain. The communication of end-points within a domain can be governed by one shared set of communication requirements.

C. Entry Point

The concept of an entry point captures a tunneling function that relays traffic from one domain to another. The tunnel characterizes the communication requirements and guarantees (e.g., security, privacy, QoS (quality of service)) that exist between the domains on both sides of the entry point. An entry point generally represents a set of IP addresses to the network into which it is added. The network structure beyond the entry point is opaque to the network resource manager. The configuration is (set of represented IP addresses), access point IP address, SLA (software licensing agreement) & policies).

D. Splitters

Splitters generally are defined as network components that distribute network traffic based on IP source address, destination address, protocol, and destination port equally among the endpoints of one domain to which they are attached. All packets belonging to one flow [TCP (Transmission Control Protocol) or UDP (User Datagram Protocol) (controlled by a configurable timeout)]. A splitter generally represents the end-points of a domain behind a virtual end-point, i.e., the splitter itself may be viewed as an end-point in other domains. The complete configuration of an end-point, encompasses its virtual end-point description (visible to the outside of the domain to which it is attached) and the end-point description that makes it a member of the domain in which it distributes traffic flows.

E. Filters

Filters generally restrict traffic flow into and out of a domain. Filters may be specified to restrict traffic to a destination endpoint inside the domain to which a filter is attached or from an endpoint to an address outside the domain. The filtering rules may specify IP address, protocol, and port for destinations of outbound and sources of inbound traffic. The filtering rules must specify the most specific representation of an IP address of one or more endpoints for the destination of inbound traffic and the source of outbound domain traffic.

A filter can be defined by an end-point, which identifies it to the outside of a domain, a set of filtering rules, and the address that it presents to the domain of which it is attached. Filters can also be configured as renumbering filters that map outgoing IP packets to a set of (good) outgoing IP addresses to disguise or abstract the individual hosts within the domain to which it is attached (see also network address translation)).

Some examples of mapping of building blocks to device configurations according to the present invention will now be described.

It is noted that there is not necessarily a one-to-one mapping between physical and functional elements, according to the present invention.

A. Endpoint Mapping

The canonical mapping of a building block to a device configuration would be to map it to a network interface with its configuration. For example, the interface may include a real IP address and a VIPA (virtual internet protocol addressing) address. Similarly, a virtual machine whose network adapter is layered atop a real device may be described by mapping the host-OSs (host-operating systems) real IP to the real-IP field of the endpoint description and the virtual NICs (virtual network interface card) address to the virtual IP field of the endpoint description.

B. End Point Mapping:
(real IP, *, *, *) VLAN (virtual local area network) or LAN (local area network) and Router configuration
(real IP, VIPA, *, *) if host with end-point supports VIPA
   VLAN, VIPA or LAN, VIPA, and Router entry
Without host support
   (NAT (network address translation) required) NAT maps VIPA to real port on end-point device. NAT attaches to router, or switch to expose VIPA on either Layer 3 or Layer 2 VLAN

C. Domain Mapping

A domain can be mapped to a VLAN (virtual local area network) if all endpoints are connected to the same IP layer 2 network fabric. The PVST (per VLAN spanning tree) algorithm will propagate the VLAN mapping across all switches to which the endpoints of a domain are attached. Similarly, if all of the endpoint addresses are real addresses and the domain encompasses all of the IP addresses on a LAN, then the domain may be mapped to an untagged layer 2 broadcast domain. If the endpoints are only connected by a routed L3 fabric, then endpoints are mapped into a shared domain by using tunneling protocols, such as L2TP (layer 2 tunneling protocol), IP over IP, GRE (generic routing encapsulation) tunneling. It is noted that the notion of a domain generally is independent of the intermediary tunneling protocol used to connect the endpoints in a restriction-free manner.

A domain is a collection of endpoints. In mapping a domain it may be necessary, to connect to the endpoints, to disallow communication with nodes outside the domain (strict domain).

If all endpoints are attached to one layer 2 fabric, the domain can be achieved by establishing a VLAN between the endpoints. ACLs (access control list) to the VLAN must be set on the ports through which the endpoints connect in a manner that allows traffic between all of them.

If all endpoints are attached to one layer 3 fabric without firewalls then connectivity is achieved by injecting routes between the endpoints into the routing protocols, e.g., OSPF (open shortest path first) or BGP (border gateway protocol).

If firewalls are installed inside the network, then it may be necessary to update the firewall with possibly n2/2 rules to allow traffic to flow between any two endpoints. However, in some cases, such may not be easily scalable, and therefore, it may be necessary to map the end-points to a special container VPN (virtual private network), which is maintained in the firewall or within a relay device. On the other hand, if the endpoints are connected to a small number of VLANs, for example, then a tunneling technology between switches (e.g., GRE or L2TP) can be used to transfer traffic between the endpoints to the switches.

D. Entry Point Mapping

Entry points typically translate to VPN access points but they may also map to gateways and the like. An entry point is a component that can be configured with privacy controls. Each entry point preferably guarantees to only allow traffic to pass into the domain to which it is attached for a well-defined set of source IP addresses. This means that an entry point will typically not relay arbitrary Internet traffic, but only a small subset of IP address prefixes.

For example, a VPN tunnel can be configured with a password, and a set of external IP addresses that are allowed to “dial in.” This function can be achieved by a Windows or Unix end-host that acts as an IPSec (secure internet protocol) tunnel server or by a dedicated VPN appliance such as the Symantec Firewall/VPN appliance.

In the later case, an entry point maps directly to a VPN appliance or IPSec tunnel, or other tunnel endpoint.

E. Filter Mapping

Access control to a domain can be achieved by filters (e.g., typically firewalls).

For example, a filter may be attached to a domain 10.1.1.* and be configured with a rule “drop source 192.168.*.* destination 10.1.1.*.” This configuration can be mapped to hardware in various ways.

For example, a network firewall device can be configured using Command Line Arguments, a multi-layer switch using “drop ip source 192.168.0.0/16” if the 10.1.1.* network is the only network attached to the switch, or traffic filtering rules at the end-points themselves, e.g., iptables -s 192.168.0.0/24-j DENY at the endpoint itself.

One important observation is that the filter is defined relative to the end-points but it is not specified where the filter is going to be enforced. This means that a filtering rule may be applied to multiple firewall devices if the endpoints are reachable via more than one firewall device. Moreover, it may be the case that a combination of firewall policies and host-based filtering policies are issued.

The filter must be directly connected via one or more interfaces to the domain for which it is filtering traffic, i.e., one of its IP addresses is member of a domain. The filter rules that control the traffic emanating from the domain are installed on the egress of the ACL-enabled devices in the egress path of the endpoints of the domain which connect to at least some devices that receive unfiltered traffic from the domain endpoints.

The ingress rules are installed in the ACL-enabled devices that are closest to the peering points with the Internet and that are in the ingress path of the domains that are to be controlled by the filter.

The mapping may be hardwired to a specific device or set of devices by manually limiting the set of ACL-enabled devices.

F. Splitter Mapping

A typical splitter configuration can map, for example, to a load-balancing device in a computer network.

For example, if the endpoints were HTTP (hypertext transfer protocol) servers, 10.1.2.1-10.1.2.10, then they would be placed inside a domain. The domain may have an attached splitter device with an external IP address, e.g., 10.1.2.100. Flows connecting to port 80 of 10.1.2.100 may be distributed to the servers 10.1.2.1-10 dynamically. This configuration cannot only be achieved using IP-load balancer devices, but also can be achieved by using reverse proxies. The splitter configuration may not distinguish between a reverse proxy and a load-balancing device. The mapping can be accomplished by the mapping algorithm.

A splitter can be mapped to an individual load balancer device or a reverse proxy.

The splitter function can be achieved by multiple devices in which the first tier of splitters relays traffic to a second tier of splitters, which eventually connects to the firewalls.

For example, the first level splitters may only load-balance based on destination address, while the second-level splitters load-balance based on source address. Splitters operate at layer 3 and expose a virtual IP address. This IP address is configured on the splitter device itself or via proxy firewall. The last tier of splitters preferably should have interfaces that act as endpoints in the domain of servers among which traffic is load balanced.

Some example of blue prints according to the present invention will now be described.

The mapping of the above abstractions to real device configurations preferably requires a detailed understanding of network topology. To limit the scope of the mapping algorithm, the present invention first defines, for example, the mapping for a set of four device constellation blue prints.

A. Computational Grid

The computational Grid generally can be defined as a set of computing devices that are placed into a domain and made accessible from a remote access point.

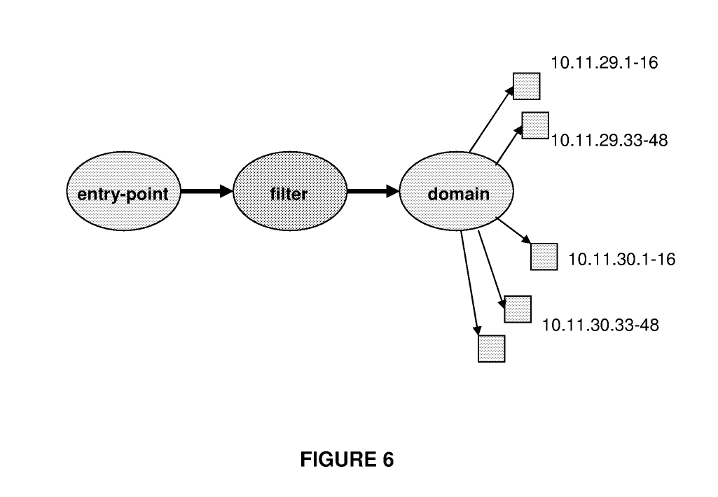

For example, with reference to FIG. 6, an exemplary blueprint 600 for a Grid deployment for one Grid customer can be as follows.
Entry point : Filter : Domain : Endpoints.

The entry point here maps into a typical VPN termination.

In this example, the filter consists of rules that allow the IP addresses that are to be forwarded on behalf of the Grid customer to the endpoints that are provided on his behalf. There is only one domain, i.e., the computing resources provided on behalf of the customer. The end-points are specified as IP or VIPA endpoints that represent the real or virtual machines that have been assigned to the customer.

The mapping algorithm can ensure that a customer's endpoints can communicate with each other and with the IP addresses that are introduced by the entry point. In any Grid deployment there are multiple configurations of the above blue print, one for each customer.

B. Web Server Farm

The pattern for a web farm can be defined, for example, as one of the two patterns (scenarios) below:
I. Splitter: Domain: filter -> (Splitter :Domain : Endpoint)+
   Or
II. Filter: Splitter : Domain: Endpoint

In scenario I, the splitter typically can map to a network load-balancing appliance that exposes a well-defined external IP address under which all of the Endpoints are to be aggregated. The Splitter then forwards the flows to a set of filter devices all of which are attached to the same domain, albeit with different IP addresses. Each filter device may be a firewall or a gateway host. The filter devices feed into one common domain, from which another splitter device (either a reverse proxy or load balancer) distributes the traffic among the end-points.

In scenario II, the forwarding path can be simpler.

The configuration of the overlay defines the configuration of the in-bound filter, which responds to the external IP address, which aggregates all of the endpoints. The filter typically maps to a firewall appliance. The filter is directly connected to a splitter device, which distributes traffic among the end-points attached to its domain.

C. Remote Branch Office
Entry point: Filter

A remote branch office may be connected to a primary site. This connectivity can be captured by the above pattern, in which a VPN appliance, IPSec tunnel or dialup implements the entry point. The entry point can be set to represent the IP addresses of the remote branch office. The filter can be configured in such a way that it only admits traffic from the set of IP addresses represented by the entry point, additional filtering rules may be submitted for the filter. Preferably, the filter also only permits traffic destined for the remote branch office to pass outbound.

D. Multi-Tier Site

A multi-tier site can be a combination of multiple applications of the web server farm blue-print.

E. It is noted that other network blueprints can be compositions of the basic blueprints defined above.

Some example processes of mapping a blue print into physical resources according to the present invention will now be described.

An appropriate blueprint can be chosen to configure the network to provide the desired network connectivity. It is noted that the blueprint can be a composition of functional building blocks. The blueprint is provided with appropriate parameters. In order to configure this service, each functional block in the blueprint is mapped to physical devices. The exemplary aspects of the present invention define this as the mapping process which consists of identifying physical resources and setting the correct parameters on these devices.

The exemplary aspects of the invention preferably require a topology based access to the network topology with physical resources (i.e., Ciscoworks) and a knowledge base that maps physical devices to functional components and vice versa. Also, the exemplary aspects of the invention preferably assume that workflows exist for configuration of the physical devices. The translation of parameters for the functional blocks to physical devices can be facilitated by a standardized naming scheme for input variables.

Some exemplary ways in which each of the five functional components can be realized by mapping to physical devices are described above.

The exemplary aspects of the invention preferably use these realizable functions to pin the blueprint on top of the available resources. One heuristic can be to first map the end-points, then fix the domain and next assign the access rules (if any) in that order. Another possible approach can be the reverse order in which first the entry-points are mapped.

Some examples of how the four exemplary blueprints can be mapped, according to the present invention, will now be described.

A. On-demand Grid:: Entry point : Filter : Domain : Endpoints

One exemplary approach can be to map all the end-points first. Next, the domain can be realized among these end-points. Once end-points are realized, a query can be made to the Grid blueprint provider to locate the node where access control preferably should be deployed for these end-points.

The exemplary aspects of the invention preferably assume that the Grid blueprint provides the list of such nodes and how to generate the ACL for these devices. These ACLs can then be deployed at appropriate devices. Next, end-points can be realized for the access to the external world. It is noted that it may be necessary to iterate until a valid set of ACLs are generated for the devices chosen for implementing the filters.

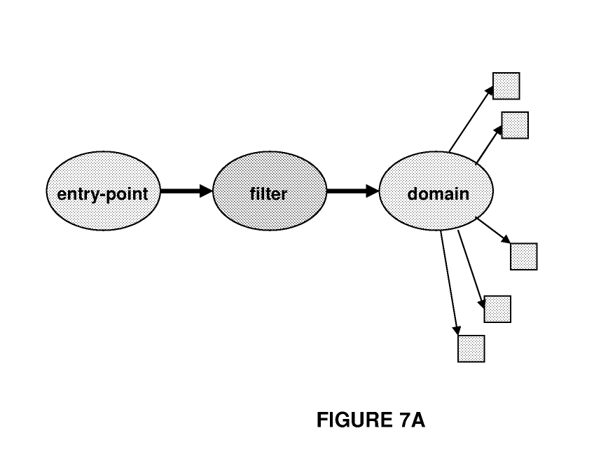

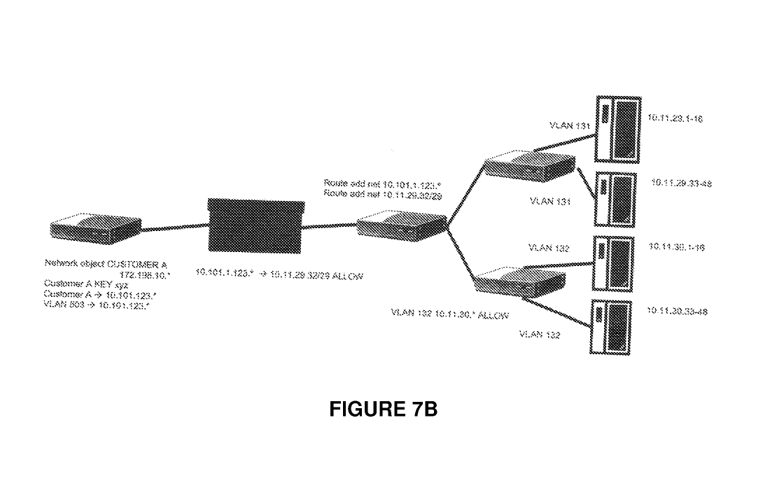

FIGS. 7A and 7B illustrate an example of mapping abstract connectivity onto network fabric, as illustrated in FIG. 6, according to the present invention.

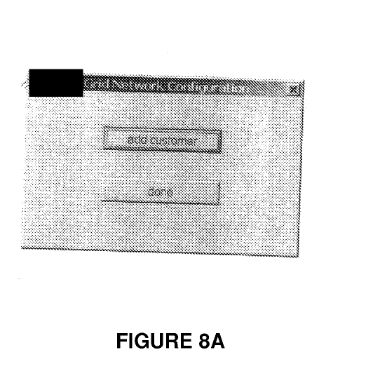

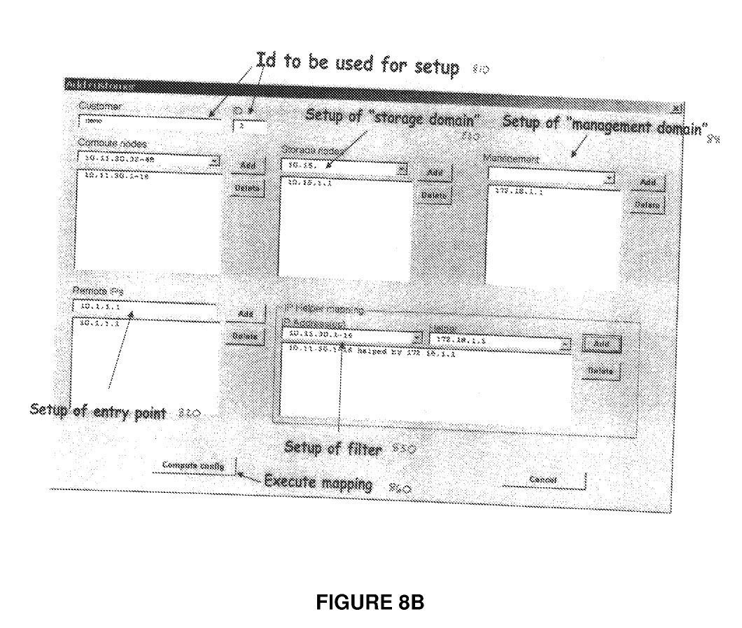

With reference to FIGS. 8A and 8B, an exemplary method of setting up a template for blue print 600, as illustrated in FIG. 6, according to the present invention, will be described.

Initially, as illustrated in FIG. 8A, a program can prompt the user whether a pattern configured in terms of the basic building blocks is to be deployed. Next, as illustrated in FIG. 8B, the method can include entering customer specific information in terms of the building blocks, for setting up the exemplary blue print 600. Such customer specific information can include setting up at least one of an ID 810 to be used for the setup, an entry point 820, storage domain 830, management domain 840, and/or a filter 850. Next, mapping 860 of the functional building blocks onto the physical resources can be executed according to the exemplary aspects of the invention.
B. Splitter: Domain: filter -> (Splitter :Domain : Endpoint)+

In this example, the splitter can be assumed to be the same for all the end-points. Using the topology service, the appropriate node can be selected to realize the splitter. Once the splitter is decided, the address can be announced to the external world. Next, end-points can be mapped onto appropriate resources and domain configuration can be set.

The mapping complexities for branch office and three tier web sites may be similar.

It is noted that additional intelligence can be added to facilitate the choice of hierarchical splitters. Also, according to the present invention, it can be possible to extend the mapping method to include cases where end-points can be chosen based on the topology and current network configuration to avoid conflicting configurations.

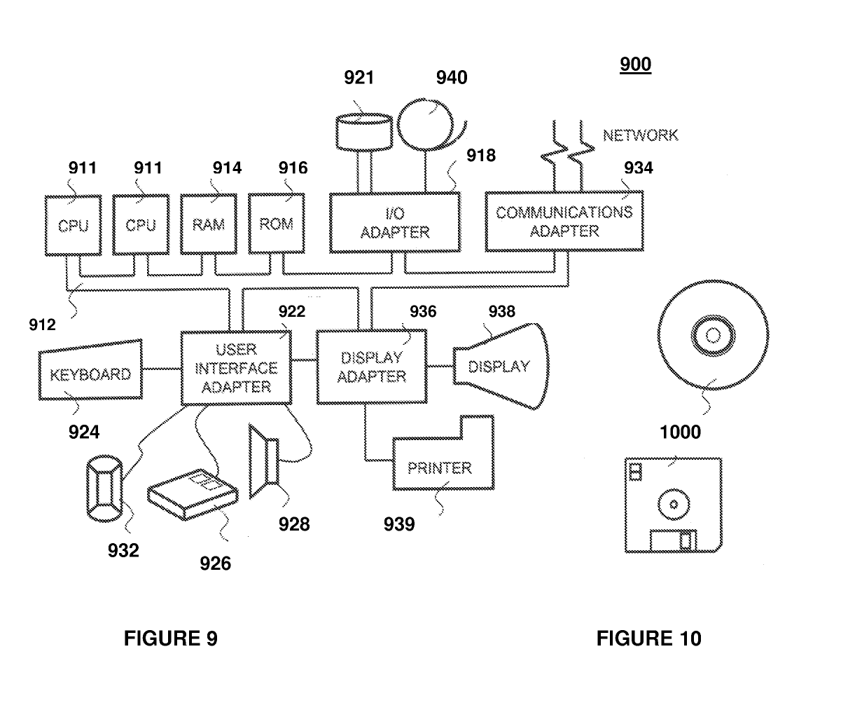

FIG. 9 illustrates a typical hardware configuration of an information handling/computer system for use with the invention and which preferably has at least one processor or central processing unit (CPU) 911.

The CPUs 911 are interconnected via a system bus 912 to a random access memory (RAM) 914, read-only memory (ROM) 916, input/output (I/O) adapter 918 (for connecting peripheral devices such as disk units 921 and tape drives 940 to the bus 912), user interface adapter 922 (for connecting a keyboard 924, mouse 926, speaker 928, microphone 932, and/or other user interface device to the bus 912), a communication adapter 934 for connecting an information handling system to a data processing network, the Internet, an Intranet, a personal area network (PAN), etc., and a display adapter 936 for connecting the bus 912 to a display device 938 and/or printer.

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

This signal-bearing media may include, for example, a RAM contained within the CPU 911, as represented by the fast-access storage for example. Alternatively, the instructions may be contained in another signal-bearing media, such as a magnetic data storage or CD-ROM diskette 1000 (FIG. 10), directly or indirectly accessible by the CPU 911.

Whether contained in the diskette 1000, the computer/CPU 911, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless.

In an illustrative embodiment of the invention, the machine-readable instructions may comprise software object code, compiled from a language such as “C”, etc.

Additionally, in yet another aspect of the present invention, it should be readily recognized by one of ordinary skill in the art, after taking the present discussion as a whole, that the present invention can serve as a basis for a number of business or service activities. All of the potential service-related activities are intended as being covered by the present invention.

The exemplary aspects of the present invention are capable of providing an abstract representation without any knowledge of network devices. Thus, the present invention allows an application to specify connectivity in terms of its functionality requirement. Moreover, the application need not know the actual devices that are present. According to the present invention, a function advantageously may be mapped to a different set of devices based on availability and existing configurations. The present invention also is capable of providing a higher possibility of satisfying a connectivity request.

While the invention has been described in terms of several exemplary embodiments, those skilled in the art will recognize that the invention can be practiced with modification within the spirit and scope of the appended claims (for example, in storage network configurations).

Further, it is noted that, Applicant's intent is to encompass equivalents of all claim elements, even if amended later during prosecution.

What is claimed is:

1. A method of configuring a network infrastructure, said method comprising:
specifying a network service required by an application as a composition of abstract functional building blocks.

2. The method according to claim 1, wherein said specifying comprises:
mapping each of said abstract functional building blocks onto available physical resources of said network infrastructure.

3. A method of configuring a network infrastructure, comprising:
representing said network infrastructure as a composition of abstract functional building blocks; and
mapping each of said abstract functional building blocks onto available physical resources of said network infrastructure.

4. The method according to claim 3, wherein said mapping comprises:
mapping each of said abstract functional building blocks onto at least one of distinct devices of said available physical resources and different kinds of devices of said available physical resources.

5. A method of configuring a network infrastructure, comprising:
representing said network infrastructure as a composition of a predetermined number of functional building blocks;
configuring a network blue print based on said predetermined number of functional building blocks; and
mapping said predetermined number of functional building blocks onto available physical resources of said network infrastructure.

6. The method according to claim 5, wherein said mapping comprises:
providing a set of algorithms for mapping said predetermined number of functional blocks on logical devices of said available physical resources of said network infrastructure.

7. The method according to claim 5, wherein said configuring comprises:
generating a set of choices for each of said predetermined number of functional blocks in an abstract connectivity;
choosing a feasible realization of the abstract connectivity on a predetermined physical network fabric of said network infrastructure; and
generating configurations using lower level configuration abstraction.

8. The method according to claim 5, wherein at least one of said predetermined number of functional building blocks is mapped onto more than one of said available physical resources of said network infrastructure.

9. The method according to claim 5, wherein said mapping is based on at least one of resource connectivity details, a current network configuration, and said network blue print.

10. The method according to claim 5, wherein said predetermined number of functional building blocks is mappable to more than one of said available physical resources of said network infrastructure.

11. The method according to claim 5, wherein said mapping comprises other than one-to-one mapping between each of said predetermined number of functional building blocks and said available physical resources of said network infrastructure.

12. A system for configuring a network infrastructure, comprising:
a representing unit that represents said network infrastructure as a composition of a predetermined number of functional building blocks;
a configuring unit that configures a network blue print based on said predetermined number of functional building blocks; and
a mapping unit that maps said predetermined number of functional building blocks onto available physical resources of said network infrastructure based on said network blue print.

13. The system according to claim 12, wherein said mapping unit includes an executing unit that maps said predetermined number of functional blocks on logical devices of said available physical resources of said network infrastructure based on a predetermined set of algorithms.

14. The system according to claim 12, wherein said configuring unit includes:
a first generating unit that generates a set of choices for each of said predetermined number of functional blocks in an abstract connectivity;
a selecting unit that selects a feasible realization of the abstract connectivity on a predetermined physical network fabric of said network infrastructure; and
a second generating unit that generates configurations using lower level configuration abstraction.

15. A system for configuring a network infrastructure, comprising:
means for representing said network infrastructure as a composition of a predetermined number of functional building blocks;
means for configuring a network blue print based on said predetermined number of functional building blocks; and
means for mapping said predetermined number of functional building blocks onto available physical resources of said network infrastructure based on said network blue print.

16. The system according to claim 15, wherein said means for mapping maps said predetermined number of functional blocks on logical devices of said available physical resources of said network infrastructure based on a predetermined set of algorithms.

17. The system according to claim 15, wherein said means for configuring includes:
first generating means for generating a set of choices for each of said predetermined number of functional blocks in an abstract connectivity;
selecting means for selecting a feasible realization of the abstract connectivity on a predetermined physical network fabric of said network infrastructure; and
second generating means for generating configurations using lower level configuration abstraction.

18. A method of deploying computing infrastructure in which computer-readable code is integrated into a computing system, and combines with said computing system to perform the method according to claim 1.

19. A computer-readable medium tangibly embodying a program of recordable, computer-readable instructions executable by a digital processing apparatus to perform the method according to claim 1.

20. The method according to claim 1, further comprising:
configuring said network infrastructure based on at least one of quality of service requirements and software licensing agreement requirements.

21. The method according to claim 20, wherein said software licensing agreement requirements comprise at least one of:
bandwidth requirements, delay requirements, and loss requirements.

22. The method according to claim 3, further comprising:
configuring said network infrastructure based on at least one of quality of service requirements and software licensing agreement requirements.

23. The method according to claim 22, wherein said software licensing agreement requirements comprise at least one of:
bandwidth requirements, delay requirements, and loss requirements.

24. The method according to claim 5, wherein said configuring comprises configuring said network blue print based on at least one of quality of service requirements and software licensing agreement requirements.

25. The method according to claim 24, wherein said software licensing agreement requirements comprise at least one of:
bandwidth requirements, delay requirements, and loss requirements.

26. The system according to claim 12, wherein said configuring unit configures said network blue print based on at least one of quality of service requirements and software licensing agreement requirements.

27. The system according to claim 26, wherein said software licensing agreement requirements comprise at least one of:
bandwidth requirements, delay requirements, and loss requirements.

28. The system according to claim 15, wherein said means for configuring configures said network blue print based on at least one of quality of service requirements and software licensing agreement requirements.

29. The system according to claim 28, wherein said software licensing agreement requirements comprise at least one of:
bandwidth requirements, delay requirements, and loss requirements.
